(19) United States
(12) Patent Application Publication
(10) Pub. No.: US 2014/0033897 A1
(43) Pub. Date: Feb. 6, 2014

(54) MUSICAL KEYBOARD IN THE FORM OF A TWO-DIMENSIONAL MATRIX

(71) Applicant: Andrey Anatolievich Bludov, Moscow (RU)

(72) Inventor: Andrey Anatolievich Bludov, Moscow (RU)

(21) Appl. No.: 14/000,217

(22) PCT Filed: Feb. 21, 2012
(86) PCT No.: PCT/RU2012/000119

§ 371 Date: Oct. 24, 2013

(30) Foreign Application Priority Data
Feb. 22, 2011 (RU) 2011106561

(51) Int. Cl. G10C 3/12

(52) U.S. Cl. CPC G10C 3/12
USPC 84/423 R

(57) ABSTRACT

The invention relates to music keyboard design. The music keyboard consists of keys which are organized in the form of a two-dimensional matrix and are ranged along one axis of the matrix as an arithmetic progression of the frequency of the sound produced and along the other axis of the matrix as an arithmetic progression of the period of the sound produced. The technical result is an improvement in the quality of the sound of the musical instrument through the elimination of acoustic interference, and greater ease of use of the major and minor scales.

### BACKGROUND OF THE INVENTION

a) Field of the Invention

The invention relates to music keyboard design.

b) Description of the Prior Art

It is known that keyboards for keyboard musical instruments can be divided into the following types:

1) self-sounding shock
celesta

2) string
shock-keyboards (piano and clavichord)
plectrum-keyboards (harpsichord and its varieties)

3) wind musical instruments
keyboard-wind (organ and its varieties)
reeds (harmonium, harmonica, accordion, melodica)

4) electronic
synthesizers,
electronic organ

An analogue of described invention is the e-key for keyboard synthesizer.

The synthesizer is an electronic musical instrument that generates (synthesizes) sound through one or more generators of the sound waves. The desired sound is achieved by changing the properties of an electric signal (analog synthesizers) or by the CPU settings (digital synthesizers).

Synthesizer, made in the form of a system-block with a keyboard, is called the keyboard synthesizer. Synthesizer as a system-block without a keyboard called a synthesizer module and is controlled by MIDI-keyboard or other device for sound control, for example, MIDI-guitar. If the keyboard has a built-in sequencer, synthesizer is called a workstation. Synthesizer as a computer program using a universal sound card and standard input-output devices (computer keyboard, mouse, monitor, headphones), is called software synthesizer.

The prototype of the invention is MIDI-keyboard for synthesizer module because synthesizer module allows using software and hardware to generate any pitch of tone. Also synthesizer module can be connected to standard or modified keyboard.

The analogue and the prototype are a software-hardware direction for development of musical instruments that gives them maximum flexibility to customize the pitch, the tone, and other characteristics of the sound in the frame of a single musical instrument.

However, the keyboard for the analogue and the prototype are designed as a one-dimensional structure.

This one-dimensional structure is the keys which are typically organized like equal-tempered scale (FIG. 1)

As is well known, 12-tone equal-tempered music scale is a geometric progression.

It is possible to mathematically calculate the frequency of the scale, using the formula:

f(i)=f₀*2^{i/12},

where f₀—frequency of standard tuning fork (eg A 440 Hz);
i—the number of semitones in the interval from the desired note to the standard tuning fork f₀. [3]

Table 1 shows the frequencies of 12-tones equal-tempered music scale, tuned to standard tuning fork (A 440 Hz).

| | sub- | | | | | | | | |
|---|---|---|---|---|---|---|---|---|---|
| To | contra | contra | great | small | 1-line | 2-line | 3-line | 4-line | 5-line |
| ne | octave | octave | octave | octave | octave | octave | octave | octave | octave |
| C | 16,35 | 32,7 | 65,41 | 130,81 | 261,63 | 523,25 | 1046,5 | 2093 | 4186,01 |
| C# | 17,32 | 34,65 | 69,3 | 138,59 | 277,18 | 554,37 | 1108,73 | 2217,46 | 4434,92 |
| D | 18,35 | 36,71 | 73,42 | 146,83 | 293,66 | 587,33 | 1174,66 | 2349,32 | 4698,64 |
| D# | 19,45 | 38,89 | 77,78 | 155,56 | 311,13 | 622,25 | 1244,51 | 2489,02 | 4978,03 |
| E | 20,6 | 41,2 | 82,41 | 164,82 | 329,63 | 659,26 | 1318,51 | 2637,02 | 5274,04 |
| F | 21,83 | 43,65 | 87,31 | 174,61 | 349,23 | 698,46 | 1396,91 | 2793,83 | 5587,65 |
| F# | 23,12 | 46,25 | 92,5 | 185 | 369,99 | 739,99 | 1479,98 | 2959,95 | 5919,91 |
| G | 24,5 | 49 | 98 | 196 | 392 | 783,99 | 1567.98 | 3135,96 | 6271,93 |
| G# | 25,96 | 51,91 | 103,83 | 207,65 | 415,3 | 830,61 | 1661,62 | 3322,44 | 6644,87 |
| A | 27,5 | 55 | 110 | 220 | 440 | 880 | 1760 | 3520 | 7040 |
| A# | 29,14 | 58,27 | 116,54 | 233,08 | 466,16 | 932,33 | 1864,66 | 3729,31 | 7458,62 |
| B | 30,87 | 61,74 | 123,47 | 246,94 | 493,88 | 987,77 | 1975,53 | 3951,07 | 7902,13 |

Natural scale (from Let, Nature—nature) or overtone scale is a series of tones, consisting of the fundamental tone and harmonic overtones. The harmonic series is an arithmetic progression (1×f, 2×f, 3×f, 4×f, 5×f, . . . ). in terms of frequency (measured in cycles per second, or hertz (Hz) where f is the fundamental frequency), the difference between consecutive harmonics is constant and equal to the fundamental frequency.

Natural scale corresponds to the spectrum of complex harmonic oscillator—natural sound source (e.g., a string or column of air in the tube).

Table 2 shows the differences between the intervals equal-tempered and natural scale

| | | | differ- |
|---|---|---|---|
| | | | ence |
| intervals | equal-tempered scale | natural scale | in cents |
| prime | 2^{0/12} = 1 = 0 cents | 1/1 = 1 = 0 cents | 0 |
| minor | 2^{1/12} ≈ 1.059463 = 100 cents | 16/15 = 1.066667 ≈ | −11.73 |
| second | | 111.73 cents | |
| major | 2^{2/12} ≈ 1.122462 = 200 cents | 9/8 = 1.125 ≈ | −3.91 |
| second | | 203.91 cents | |
| minor | 2^{3/12} ≈ 1.189207 = 300 cents | 6/5 = 1.2 ≈ | −15.64 |
| third | | 315.64 cents | |
| major | 2^{4/12} ≈ 1.259921 = 400 cents | 5/4 = 1.25 ≈ | 13.69 |
| third | | 386.31 cents | |
| fourth | 2^{5/12} ≈ 1.334840 = 500 cents | 4/3 = 1.33(3) ≈ | 1.96 |
| | | 498.04 cents | |
| tritone | 2^{6/12} ≈ 1.414214 = 600 cents | 44/32 = 1.406250 ≈ | 9.78 |
| | | 590.22 cents | |
| fifth | 2^{7/12} ≈ 1.498307 = 700 cents | 3/2 = 1.5 ≈ | −1.96 |
| | | 701.96 cents | |
| minor | 2^{8/12} ≈ 1.587401 = 800 cents | 8/5 = 1.6 ≈ | −13.69 |
| sixth | | 813.69 cents | |
| major | 2^{9/12} ≈ 1.681793 = 900 cents | 5/3 = 1.66(6) ≈ | 15.64 |
| sixth | | 884.36 cents | |
| minor | 2^{10/12} ≈ 1.781797 = 1000 cents | 16/9 = 1.77(7) ≈ | 3.91 |
| seventh | | 996.09 cents | |
| major | 2^{11/12} ≈ 1.887749 = 1100 cents | 15/8 = 1.875 ≈ | 11.73 |
| seventh | | 1088.27 cents | |
| prime | 2^{12/12} = 2 = 1200 cents | 16/8 = 2 = | 0 |
| (octave) | | 1200 cents | |

The table 2 shows that octave is the only natural interval in the equal-tuning scale.

The difference between natural and equal-tempered intervals is the reason for the decrease of quality of musical instruments with equal-tempered tuning, due to the appearance of acoustic interference.

Also, when playing in major or minor gammas, there is a need of skipping certain keys that do not fit into the tonalities.

The above-mentioned disadvantages, namely: the absence of natural intervals (except the octave) and a mixed arrangement of keys for major and minor gammas are the “charges” for the design of the keyboard as a one-dimensional structure.

Thus, to reach the desired technical goal, namely:

a) an improvement in the quality of the sound of the musical instrument through the elimination of acoustic interference

6) continuous and, therefore, logical location of major and minor scales, the design of the keyboard as a two-dimensional structure is proposed.

The matrix of this keyboard is presented in FIG. 2.

### EXAMPLE

When you configure the keyboard to the standard tuning fork (the note “a”—440 Hz), the matrix looks like shown in Table 3

TABLE 3
The matrix of the frequency ratio when tuned to standard tuning fork:
note “a” - 440 Hz. The frequencies in Hz are indicated in parentheses.

| c | c | g | c | e | g | b | c |
|---|---|---|---|---|---|---|---|
| 1/1 | 2/1 | 3/1 | 4/1 | 5/1 | 6/1 | 7/1 | 8/1 |
| (264) | (528) | (792) | (1056) | (1320) | (1584) | (1848) | (2112) |
| c | c | g | c | e | g | b | c |
| 1/2 | 2/2 | 3/2 | 4/2 | 5/2 | 6/2 | 7/2 | 8/2 |
| (132) | (264) | (396) | (528) | (660) | (792) | (924) | (1056) |
| f | f | c | f | a | c | d | f |
| 1/3 | 2/3 | 3/3 | 4/3 | 5/3 | 6/3 | 7/3 | 8/3 |
| (88) | (176) | (264) | (352) | (440) | (528) | (616) | (704) |
| c | c | g | c | e | g | b | c |
| 1/4 | 2/4 | 3/4 | 4/4 | 5/4 | 6/4 | 7/4 | 8/4 |
| (66) | (132) | (198) | (264) | (330) | (396) | (462) | (528) |
| a-flat | a-flat | d-sharp | a-flat | c | d-sharp | f-sharp | a-flat |
| 1/5 | 2/5 | 3/5 | 4/5 | 5/5 | 6/5 | 7/5 | 8/5 |
| (52.8) | (105.6) | (158.4) | (211.2) | (264) | (316.8) | (369.6) | (422.4) |
| f | f | c | f | a | c | d | f |
| 1/6 | 2/6 | 3/6 | 4/6 | 5/6 | 6/6 | 7/6 | 8/6 |
| (44) | (88) | (132) | (176) | (220) | (264) | (308) | (352) |
| c-sharp | c-sharp | b-flat | c-sharp | f-sharp | b-flat | c | c-sharp |
| 1/7 | 2/7 | 3/7 | 4/7 | 5/7 | 6/7 | 7/7 | 8/7 |
| (37.7) | (75.4) | (113.1) | (150.9) | (188.6) | (226.3) | (264) | (301.7) |
| c | c | g | c | e | g | b | c |
| 1/8 | 2/8 | 3/8 | 4/8 | 5/8 | 6/8 | 7/8 | 8/8 |
| (33) | (66) | (99) | (132) | (165) | (198) | (231) | (264) |

The given matrix keyboard design allows achieving the following technical goals:

1. When moving horizontally or vertically between adjacent keys or playing a chord, the dissonant intervals and acoustic interference do not appear, because the matrix is based on natural musical intervals.

2. The intermittent keys location for major and minor musical scales is eliminated. Major and minor musical scales are perpendicular.

In the given example the major triads are arranged horizontally (c, e, g—line 4 from the top), the minor—vertically (c, d-sharp, g—column 6).

Besides, the matrix keyboard design has the following properties:

1. Tonic (the keynote) is the diagonal of matrix. In the given example the tonic note “C” has the frequency of 264 Hz. (FIG. 5)

2. The matrix contains all 12 chromatic intervals (FIG. 5).

3. The matrix design may increase in its axis without losing its properties, but in terms of psychoacoustics the basic (the optimal) matrix is the square matrix of 8×8 (64 keys), while the minimal one is of 4×4 (16 keys) (FIG. 3)

4. The range of the basic matrix (8×8) is 6 octaves and it can be shifted at least to one octave. In the example, the range of the matrix is from “contra-octave” to the beginning of “4-line octave”.

5) The changing of tonic (keynote) pitch requires reconfiguring of the matrix.

This matrix keyboard design is the technical presentation of the following definitions:

1. The “natural minor” is a scale built like a vertical descending arithmetic progression of the period of the base of the matrix. The arithmetical ratio is equal to the negative value of 1/8 of the period. At the same time the 3^{rd}, the 4^{th} and the 5^{th} periods or, terms of progression minor progression, this matrix's top row is an arithmetic progression of the tonic frequency . The 6, 5, 4 members of the “minor progression” form a minor chord (see FIG. 2 and FIG. 5).

2. The “natural major” is a scale built like an increasing arithmetic progression of frequency of the left column of the matrix. The arithmetical ratio is also equal to the same frequency. At the same time, the 4^{th} , the 5^{th} and the 6^{th} terms of the progression form the major triad. (see FIG. 2 and table 5).

Matrix keyboard design for musical instruments keeps its advantages and features of the case turns on its axis.

### SUMMARY OF THE INVENTION

An object of the present invention is to provide the music keyboard design for

a) improvement in the quality of the sound of the musical instrument through the elimination of acoustic interference,

b) remove mixed arrangement of keys for major and minor scales

According to the invention there is provided:

a) the music keyboard consisting of keys which are organized in the form of a two-dimensional matrix and are ranged along one axis of the matrix as an arithmetic progression of the frequency of the sound produced and along the other axis of the matrix as an arithmetic progression of the period of the sound produced,

b) a method for producing of musical intervals are ranged like in the described matrix.

### BRIEF DESCRIPTION OF THE DRAWINGS

FIG. 1. Keyboard for equal-tempered scale

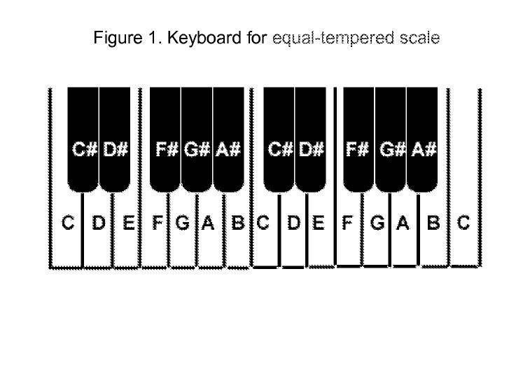

FIG. 2. The relationship of the periods and the frequencies of the sound produced

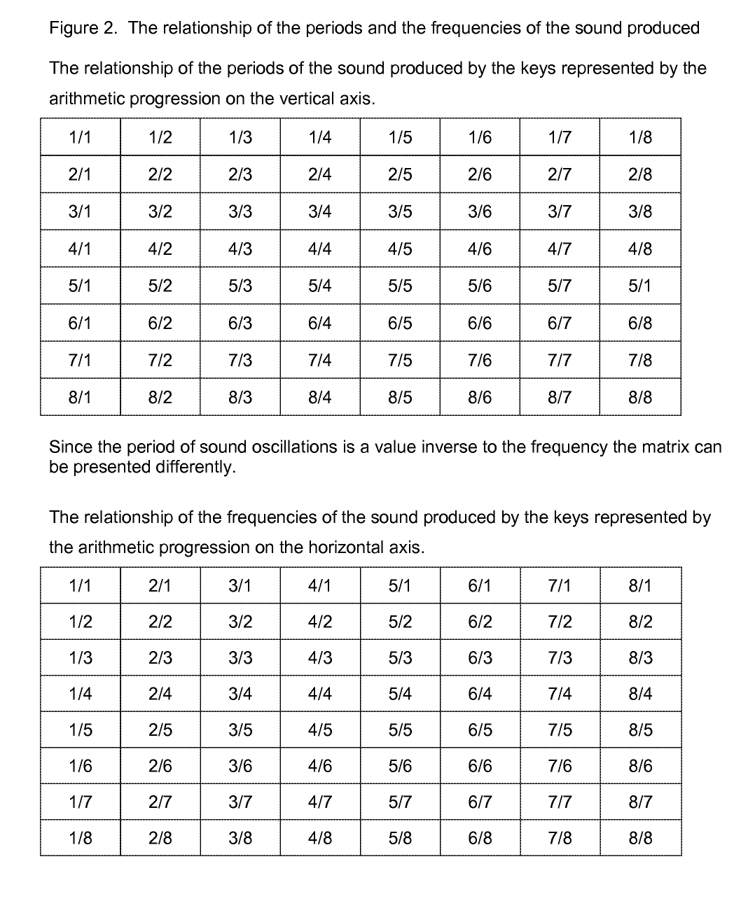

FIG. 3 Strict keyboard design

FIG. 4. Keyboard design with selected tonic (keynote).

FIG. 5. The matrix of the frequency ratio when it is tuned to standard tuning fork: note “A”—440 Hz. In parentheses there are the frequencies in Hz

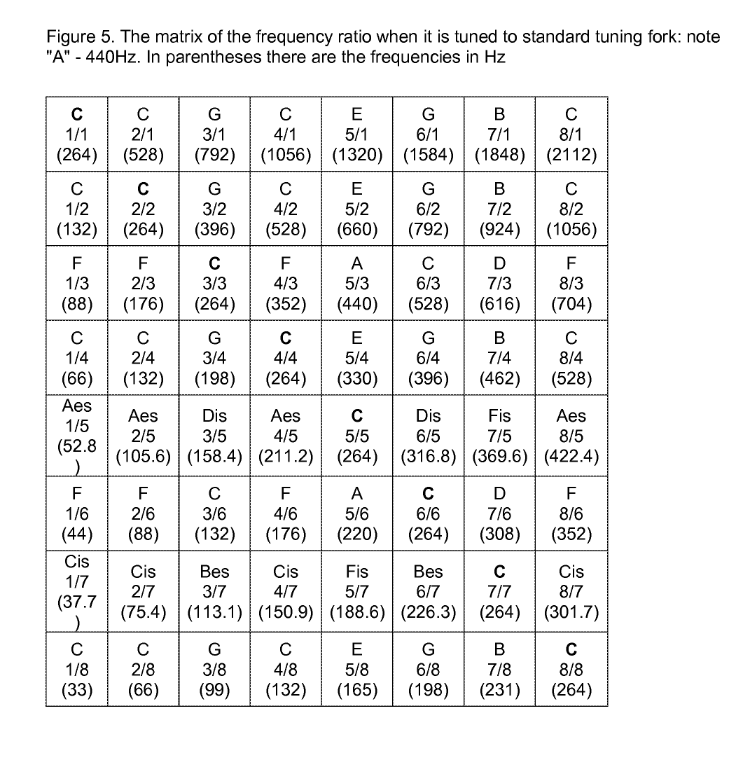

### DESCRIPTION OF THE PREFERRED EMBODIMENT

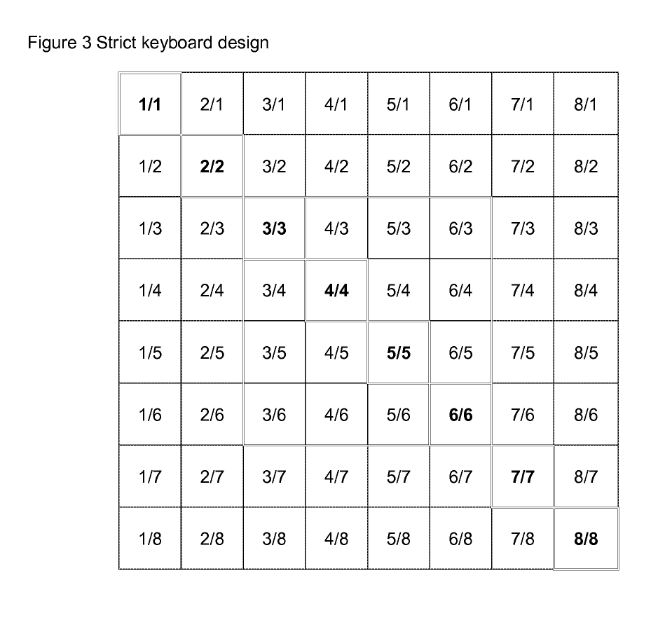

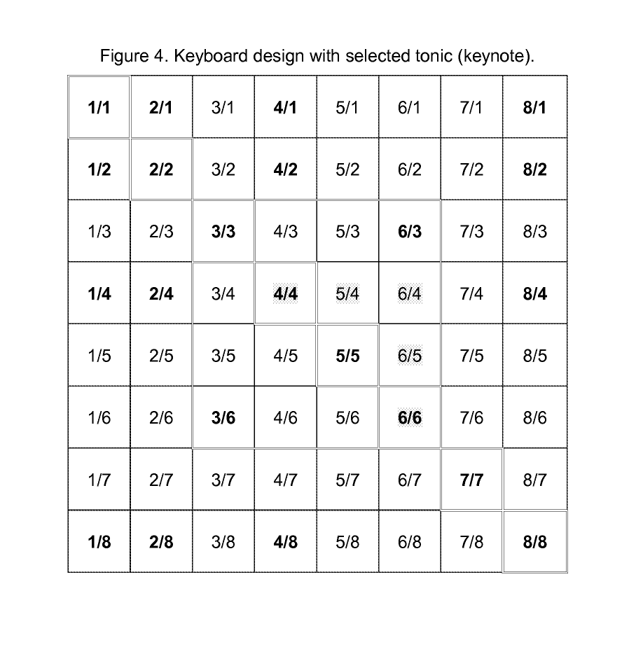

It is known audio control device—keyboard for musical instruments, in particular, the keyboard for synthesizer. Technically easy to change the design of the keyboard and transform it into a matrix. In particular, the design of the keyboard, in the simplest case, may look like shown in FIG. 3 or FIG. 4.

Since the keyboard is a sound control device, for example, for synthesizer module that is selected like the prototype, there are standard hardware and software tools to perform basic operations on matrices.

In this case, it is the multiplication matrix to number. These operations will expand the functionality of a musical instrument and arbitrarily set the value of the tonic.

The using of this keyboard is more convenient than a standard keyboard for piano or synthesizer. To simplify the perception of musical intervals should mark out all tonics, the diagonal of the tonic and major-minor chords as in FIGS. 3 and 4.

1. The music keyboard comprising the keys which are ranged by the frequency of the sound produced, characterized in that the music keyboard keys are organized in the form of a two-dimensional matrix and are ranged along one axis of the matrix as an arithmetic progression of the frequency of the sound produced and along the other axis of the matrix as an arithmetic progression of the period of the sound produced.
